(19) United States
(12) Patent Application Publication
(10) Pub. No.: US 2024/0119484 A1
(43) Pub. Date: Apr. 11, 2024

(54) PRIVACY-PRESERVING RULES-BASED TARGETING USING MACHINE LEARNING

(71) Applicant: Microsoft Technology Licensing, LLC, Redmond, WA (US)

(72) Inventor: Kiran RAMA, Bangalore (IN)

(21) Appl. No.: 17/960,618

(22) Filed: Oct. 5, 2022

(51) Int. Cl. G06Q 30/02

(52) U.S. Cl. CPC G06Q 30/0271

(57) ABSTRACT

Techniques are described herein that are capable of providing privacy-preserving rules-based targeting using machine learning. Ranks are assigned to entities using a machine learning model. Values of each targetable feature associated with the respective entities are ordered. For each targetable feature, the entities are sorted among bins based on the values of the feature associated with the respective entities. For each targetable feature, a bin is selected from the bins that are associated with the feature based on the selected bin including more entities having respective ranks that are within a designated range than each of the other bins that are associated with the feature. A targeting rule is established, indicating a prerequisite for targeting an entity. The prerequisite indicating that the value of each targetable feature associated with the entity is included in a respective interval associated with the selected bin for the feature.

### BACKGROUND

Machine learning models have become quite popular and have added substantial business value through the ability to target users (e.g., consumers) in a personalized manner. Two common types of machine learning models are classification models (a.k.a. propensity models) and recommender models. Classification models rank users according to their decreasing likelihood to perform a particular activity. Recommender models recommend the best item for a given user from a targeting perspective. In traditional machine learning-based targeting techniques, each user is targeted using a user-specific identifier, which uniquely identifies the user. Examples of a user-specific identifier include but are not limited to a cookie, an email identifier, and a phone number (e.g., a mobile number).

However, with the advent of privacy laws and regulations, such as Europe's General Data Protection Regulation (GDPR) and the California Consumer Privacy Act (CCPA), it has become quite difficult to target users in a personalized manner. Under such privacy laws and regulations, targeting a particular user using a user-specific identifier (e.g., a cookie, phone number, or email identifier) often is considered an invasion of the user's privacy.

Some conventional techniques attempt to anonymize user-specific identifiers by mapping the user-specific identifiers to hash keys. However, such hash keys are increasingly being banned by regulations across a variety of jurisdictions.

### SUMMARY

It may be desirable to approximate personalized targeting of users by using machine learning to implement privacy-preserving rules-based targeting of the users. By doing so, the power of machine learning models may be leveraged in the absence of the ability to target the users individually using personal identifiers, as enforced by legislation. A same or similar result may be accomplished by using an approximation of rules that identify a group of users for targeting without the need to leverage their personal identifiers. For instance, output of a machine learning model, which indicates relative probabilities of users to perform an operation, and targetable features associated with the users may be analyzed to establish a targeting rule, indicating which users are to be targeted (e.g., with regard to the operation). A targetable feature is a feature that complies with a targeting policy, whereas a non-targetable feature is a feature that does not comply with the targeting policy. The targeting policy may include or reference privacy laws and regulations and company-specific restrictions. For instance, the company-specific restrictions may be based on ethical concerns or the computational burden of computing any one or more features of the users.

Various approaches are described herein for, among other things, providing privacy-preserving rules-based targeting using machine learning. In an example approach, ranks are assigned to respective entities using a machine learning model. The ranks correspond to respective likelihoods of the respective entities to perform a designated operation. Features that are associated with the entities are categorized among a targetable category and a non-targetable category. The targetable category includes each of the features that complies with a targeting policy. The non-targetable category includes each of the features that does not comply with the targeting policy. For each feature in the targetable category, values of the feature that are associated with the respective entities are ordered in an order that corresponds to the respective values. For each feature in the targetable category, the entities are sorted among bins that are associated with the feature such that each bin includes a respective subset of the entities that is associated with a respective subset of the ordered values of the feature. For each feature in the targetable category, a bin is selected from the bins that are associated with the feature based on the selected bin including a number of the entities having respective ranks that are within a designated range being greater than a number of the entities having respective ranks that are within the designated range in each of the other bins that are associated with the feature. An interval for each feature in the targetable category that corresponds to the subset of the ordered values of the feature that is associated with the subset of the entities in the selected bin for the feature is defined. A targeting rule is established. The targeting rule indicates a prerequisite that each entity to be targeted with an action (e.g., a designated action) satisfies a criterion. The criterion specifies that the value of each feature of the targetable category that is associated with the entity is included in the respective interval that is defined for the feature.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example privacy-preserving rules-based targeting system in accordance with an embodiment.

FIGS. 2-3 depict flowcharts of example methods for providing privacy-preserving rules-based targeting using machine learning in accordance with embodiments.

FIG. 4 is a block diagram of an example computing system in accordance with an embodiment.

FIG. 5 is a spreadsheet that illustrates ranking entities, ordering values of features, and sorting the entities among bins in accordance with an embodiment.

FIG. 6 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Example Embodiments

It may be desirable to approximate personalized targeting of users by using machine learning to implement privacy-preserving rules-based targeting of the users. By doing so, the power of machine learning models may be leveraged in the absence of the ability to target the users individually using personal identifiers, as enforced by legislation. A same or similar result may be accomplished by using an approximation of rules that identify a group of users for targeting without the need to leverage their personal identifiers. For instance, output of a machine learning model, which indicates relative probabilities of users to perform an operation, and targetable features associated with the users may be analyzed to establish a targeting rule, indicating which users are to be targeted (e.g., with regard to the operation). A targetable feature is a feature that complies with a targeting policy, whereas a non-targetable feature is a feature that does not comply with the targeting policy. The targeting policy may include or reference privacy laws and regulations and company-specific restrictions. For instance, the company-specific restrictions may be based on ethical concerns or the computational burden of computing any one or more features of the users.

Example embodiments described herein are capable of providing privacy-preserving rules-based targeting using machine learning. In an example embodiment, ranks are assigned to respective entities using a machine learning model. The ranks correspond to respective likelihoods of the respective entities to perform a designated operation. Features that are associated with the entities are categorized among a targetable category and a non-targetable category. The targetable category includes each of the features that complies with a targeting policy. The non-targetable category includes each of the features that does not comply with the targeting policy. For each feature in the targetable category, values of the feature that are associated with the respective entities are ordered in an order that corresponds to the respective values. For each feature in the targetable category, the entities are sorted among bins that are associated with the feature such that each bin includes a respective subset of the entities that is associated with a respective subset of the ordered values of the feature. For each feature in the targetable category, a bin is selected from the bins that are associated with the feature based on the selected bin including a number of the entities having respective ranks that are within a designated range being greater than a number of the entities having respective ranks that are within the designated range in each of the other bins that are associated with the feature. An interval for each feature in the targetable category that corresponds to the subset of the ordered values of the feature that is associated with the subset of the entities in the selected bin for the feature is defined. A targeting rule is established. The targeting rule indicates a prerequisite that each entity to be targeted with an action (e.g., a designated action) satisfies a criterion. The criterion specifies that the value of each feature of the targetable category that is associated with the entity is included in the respective interval that is defined for the feature.

Example techniques described herein have a variety of benefits as compared to conventional techniques for performing machine learning-based targeting. For instance, the example techniques are capable of leveraging the power of machine learning models for purposes of targeting users in absence of the ability to target the users individually. To this end, the example techniques approximate personalized targeting of the users by using machine learning to implement privacy-preserving rules-based targeting of the users. Accordingly, the example techniques may increase privacy of the users. By increasing the privacy of the user, security of the users may be increased.

The example techniques may increase accuracy, precision, and/or reliability of predictions that are provided by a machine learning model that does not target users individually. For instance, by approximating personalized targeting of the users (rather than targeting the users individually), the example techniques may target a substantial proportion (e.g., 75-80%) of the same users as conventional techniques that target users individually.

The example techniques may reduce an amount of time and/or resources (e.g., processor cycles, memory, network bandwidth) that is consumed to target users by narrowing targeting efforts to users who have a relatively higher likelihood of performing a desired action as a result of the targeting. For instance, by approximating personalized targeting of the users, the time and/or resources that would have been consumed by targeting users who don't have a relatively higher likelihood of performing the desired action is reduced (e.g., avoided). By reducing the amount of time and/or resources that is consumed by a computing system to target users, the efficiency of the computing system may be increased.

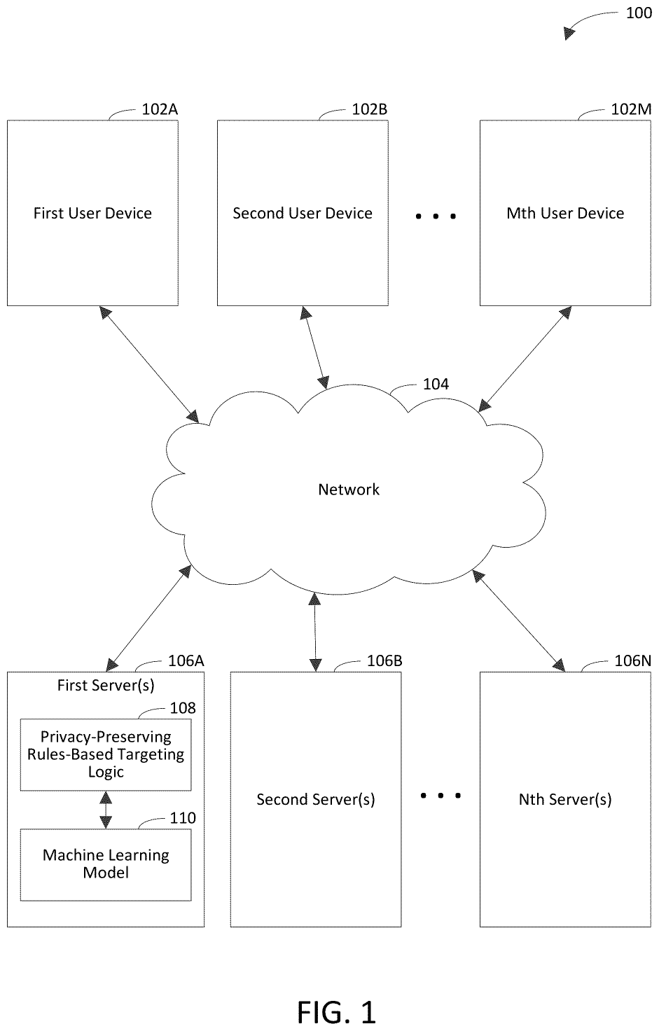

FIG. 1 is a block diagram of an example privacy-preserving rules-based targeting system 100 in accordance with an embodiment. Generally speaking, the privacy-preserving rules-based targeting system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the privacy-preserving rules-based targeting system 100 provides privacy-preserving rules-based targeting using machine learning. Detail regarding techniques for providing privacy-preserving rules-based targeting using machine learning is provided in the following discussion.

As shown in FIG. 1, the privacy-preserving rules-based targeting system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes a processing system comprising at least one processor that is capable of manipulating data in accordance with a set of instructions. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the privacy-preserving rules-based targeting system 100.

The first server(s) 106A are shown to include privacy-preserving rules-based targeting logic 108 and a machine learning model 110 for illustrative purposes. The privacy-preserving rules-based targeting logic 108 is configured to provide privacy-preserving rules-based targeting using the machine learning model 110. For instance, the privacy-preserving rules-based targeting logic 108 assigns ranks to respective entities using the machine learning model 110. The ranks correspond to respective likelihoods of the respective entities to perform a designated operation. The privacy-preserving rules-based targeting logic 108 categorizes features that are associated with the entities among a targetable category and a non-targetable category. The targetable category includes each of the features that complies with a targeting policy. The non-targetable category includes each of the features that does not comply with the targeting policy. For each feature in the targetable category, the privacy-preserving rules-based targeting logic 108 orders values of the feature that are associated with the respective entities in an order that corresponds to the respective values. For each feature in the targetable category, the privacy-preserving rules-based targeting logic 108 sorts the entities among bins that are associated with the feature such that each bin includes a respective subset of the entities that is associated with a respective subset of the ordered values of the feature. For each feature in the targetable category, the privacy-preserving rules-based targeting logic 108 selects a bin from the bins that are associated with the feature based on the selected bin including a number of the entities having respective ranks that are within a designated range being greater than a number of the entities having respective ranks that are within the designated range in each of the other bins that are associated with the feature. The privacy-preserving rules-based targeting logic 108 defines an interval for each feature in the targetable category that corresponds to the subset of the ordered values of the feature that is associated with the subset of the entities in the selected bin for the feature. The privacy-preserving rules-based targeting logic 108 establishes a targeting rule, which indicates a prerequisite that each entity to be targeted with an action satisfies a criterion. The criterion specifies that the value of each feature of the targetable category that is associated with the entity is included in the respective interval that is defined for the feature.

The privacy-preserving rules-based targeting logic 108 may use the machine learning model 110 to analyze (e.g., develop and/or refine an understanding of) the values of the features that are associated with the entities and targeted actions, relationships between the values and the targeted actions, and confidences in the aforementioned relationships. Accordingly, the machine learning model 110 may learn probabilities of the entities to perform the targeted actions. For instance, the machine learning model 110 may find patterns in the values that indicate the aforementioned probabilities.

In some example embodiments, the privacy-preserving rules-based targeting logic 108 uses a neural network to perform the machine learning to determine (e.g., predict) the relationships between the values of the features and the targeted actions, and the confidences in the relationships. The privacy-preserving rules-based targeting logic 108 uses those relationships to determine (e.g., predict) whether an entity will perform a targeted action.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the privacy-preserving rules-based targeting logic 108 employs a feed forward neural network to train the machine learning model 110, which is used to determine ML-based confidences. Such ML-based confidences may be used to determine likelihoods that events will occur.

A transformer-based neural network is a neural network that incorporates a transformer. A transformer is a deep learning model that utilizes attention to differentially weight the significance of each portion of sequential input data. Attention is a technique that mimics cognitive attention. Cognitive attention is a behavioral and cognitive process of selectively concentrating on a discrete aspect of information while ignoring other perceivable aspects of the information.

Accordingly, the transformer uses the attention to enhance some portions of the input data while diminishing other portions. The transformer determines which portions of the input data to enhance and which portions of the input data to diminish based on the context of each portion. For instance, the transformer may be trained to identify the context of each portion using any suitable technique, such as gradient descent.

In an example embodiment, the transformer-based neural network generates a targeting model (e.g., to indicate entities to target) by utilizing information, such as the values of the features that are associated with the entities and the targeted actions, probabilities that the values of the features correspond to the targeted actions, and ML-based confidences that are derived therefrom.

In example embodiments, the privacy-preserving rules-based targeting logic 108 includes training logic and inference logic. The training logic is configured to train a machine learning algorithm that the inference logic uses to determine (e.g., infer) the ML-based confidences. For instance, the training logic may provide sample entities, sample features, sample values of the features that are associated with the sample entities, sample target actions, sample relationships between the sample values and the sample targeted actions, and sample probabilities of the sample entities to perform the sample targeted actions. The sample data may be labeled. The machine learning algorithm may be configured to derive relationships between the features, the values of the features, the targeted actions, the probabilities of the entities to perform the targeted actions, and the resulting ML-based confidences. The inference logic is configured to utilize the machine learning algorithm, which is trained by the training logic, to determine the ML-based confidence when the aforementioned features (and values thereof), targeted actions, probabilities, and ML-based confidences are provided as inputs to the algorithm.

The privacy-preserving rules-based targeting logic 108 may be implemented in various ways to provide privacy-preserving rules-based targeting using the machine learning model 110, including being implemented in hardware, software, firmware, or any combination thereof. For example, the privacy-preserving rules-based targeting logic 108 may be implemented as computer program code configured to be executed in one or more processors. In another example, at least a portion of the privacy-preserving rules-based targeting logic 108 may be implemented as hardware logic/electrical circuitry. For instance, at least a portion of the privacy-preserving rules-based targeting logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

The privacy-preserving rules-based targeting logic 108 and the machine learning model 110 are shown to be incorporated in the first server(s) 106A for illustrative purposes and are not intended to be limiting. It will be recognized that the privacy-preserving rules-based targeting logic 108 (or any portion(s) thereof) may be incorporated in any one or more of the servers 106A-106N, any one or more of the user devices 102A-102M, or any combination thereof. For example, client-side aspects of the privacy-preserving rules-based targeting logic 108 may be incorporated in one or more of the user devices 102A-102M, and server-side aspects of privacy-preserving rules-based targeting logic 108 may be incorporated in one or more of the servers 106A-106N. It will be further recognized that the machine learning model 110 (or any portion(s) thereof) may be incorporated in any one or more of the servers 106A-106N, any one or more of the user devices 102A-102M, or any combination thereof.

In example embodiments, the machine learning model 110 is incorporated into the privacy-preserving rules-based targeting logic 108.

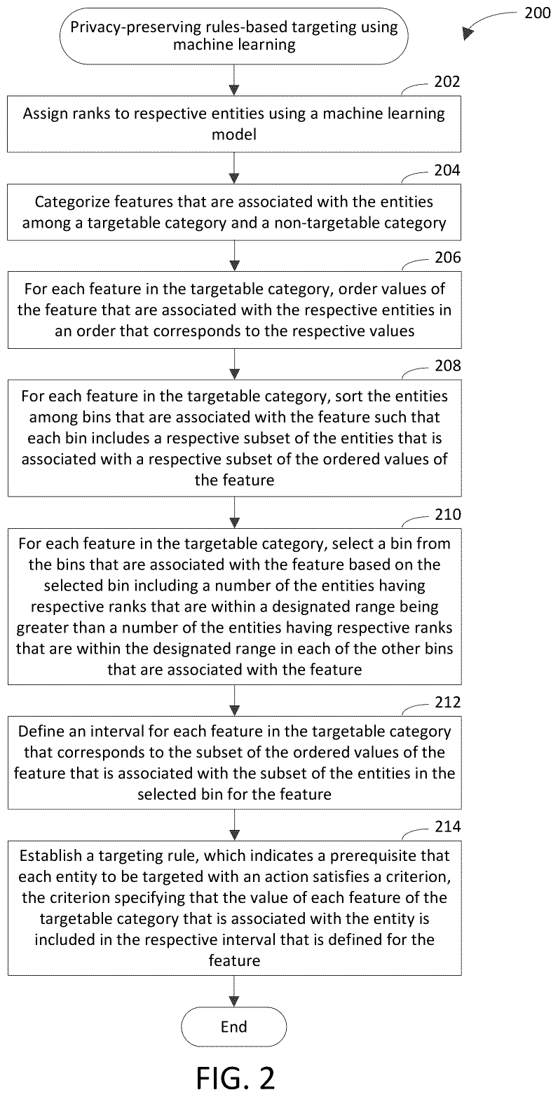

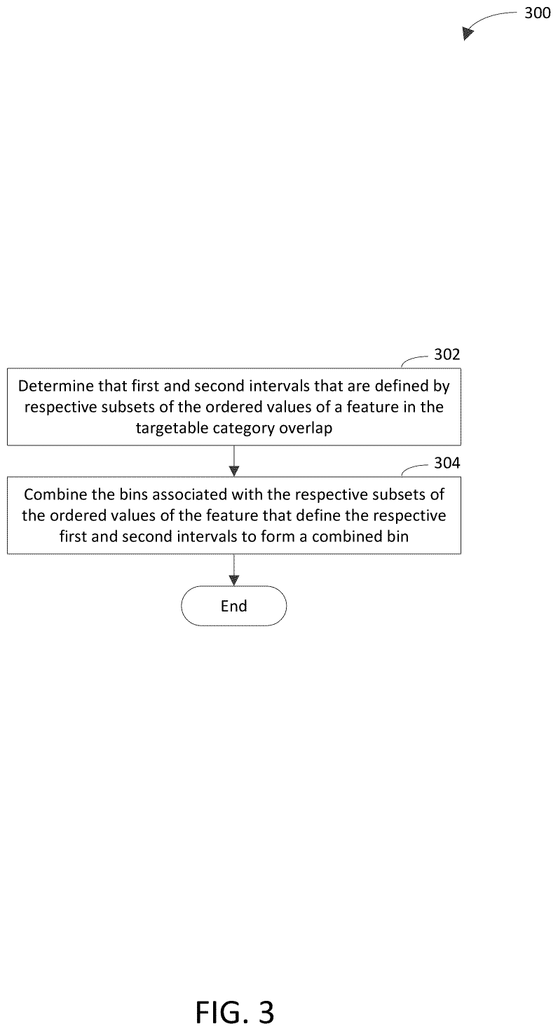

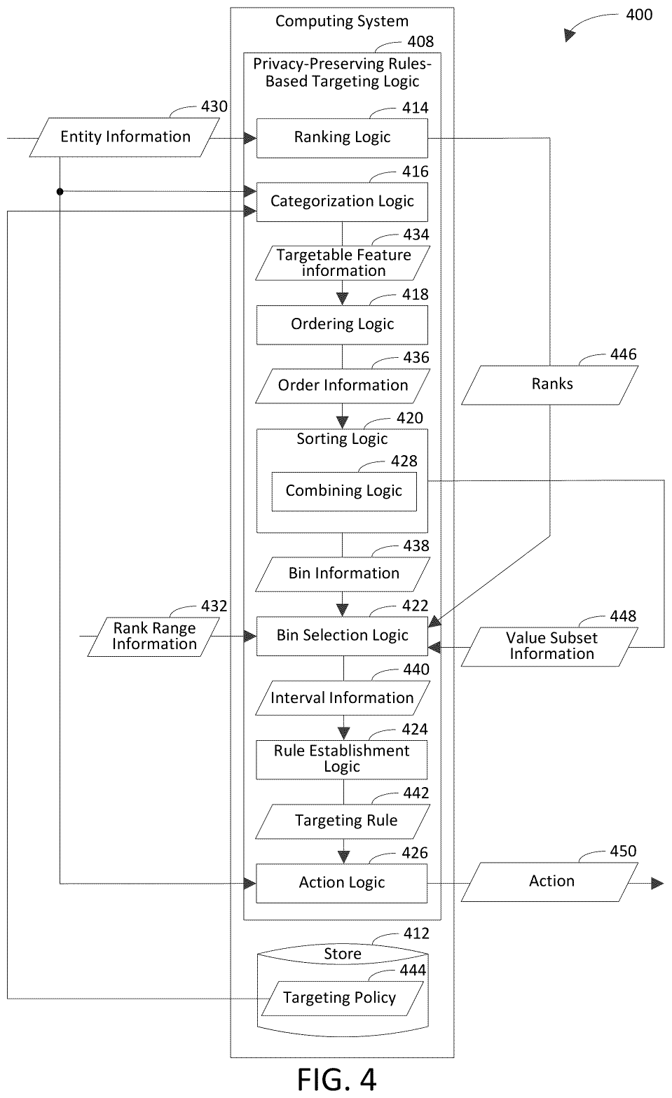

FIGS. 2-3 depict flowcharts 200 and 300 of example methods for providing privacy-preserving rules-based targeting using machine learning in accordance with embodiments. Flowcharts 200 and 300 may be performed by the first server(s) 106A shown in FIG. 1, for example. For illustrative purposes, flowcharts 200 and 300 are described with respect to computing system 400 shown in FIG. 4, which is an example implementation of the first server(s) 106A. As shown in FIG. 4, the computing system 400 includes privacy-preserving rules-based targeting logic 408 and a store 412. The privacy-preserving rules-based targeting logic 408 includes ranking logic 414, categorization logic 416, ordering logic 418, sorting logic 420, bin selection logic 422, rule establishment logic 424, and action logic 426. The sorting logic 418 includes combining logic 428. The store 412 may be any suitable type of store. One type of store is a database. For instance, the store 412 may be a relational database, an entity-relationship database, an object database, an object relational database, an extensible markup language (XML) database, etc. The store 412 is shown to store a targeting policy 444 for non-limiting, illustrative purposes. Further structural and operational embodiments will be apparent to persons skilled in the relevant art(s) based on the discussion regarding flowcharts 200 and 300.

As shown in FIG. 2, the method of flowchart 200 begins at step 202. In step 202, ranks are assigned to respective entities using a machine learning model. The ranks correspond to respective likelihoods of the respective entities to perform a designated operation. The machine learning model may be any arbitrary machine learning model. In an example implementation, the ranking logic 414 assigns ranks 446 to the respective entities using the machine learning model (e.g., machine learning model 110 of FIG. 1). The ranks 446 correspond to the respective likelihoods of the respective entities to perform the designated operation. In accordance with this implementation, the ranking logic 414 analyzes entity information 430 to determine the ranks 446. For example, the entity information 430 may indicate the likelihoods of the respective entities to perform the designated operation. In accordance with this example, the entity information 430 may cross-reference identifiers associated with the respective entities with the respective likelihoods.

At step 204, features that are associated with the entities are categorized among a targetable category and a non-targetable category. In an example embodiment, each feature associated with an entity is a characteristic of the entity. Examples of a feature of an entity include but are not limited to a number of times the entity has performed an action (e.g., download a document, purchase a good or service, visit a website, click in a webpage), an amount of time that has passed since the entity last performed the action, a number of years the entity has used a product or service, which products or services the entity has used or is currently using, a credit score of the entity, and whether the entity is married. The targetable category includes each of the features that complies with a targeting policy. In an example embodiment, the targeting policy indicates which of the features are allowed to be used to target an entity and/or which of the features are not allowed to be used to target an entity. The targetable category may include any suitable number of features (e.g., 1, 2, 100, or 5 million). The non-targetable category includes each of the features that does not comply with the targeting policy. The non-targetable category may include any suitable number of features (e.g., 0, 1, 300, or 9 million). In an example embodiment, the targetable category includes each of the features that includes information that identifies a particular one of the entities. In accordance with this embodiment, the non-targetable category includes each of the features that does not identify a particular one of the entities.

In an example implementation, the categorization logic 416 categorizes the features that are associated with the entities among the targetable category and the non-targetable category. For example, the entity information 430 may indicate the features that are associated with the entities, and the categorization logic 416 may analyze the entity information 430 to determine the features. The categorization logic 416 may compare each of the determined features to the targeting policy 444 to determine whether the feature complies with the targeting policy 444. If the feature complies with the targeting policy 444, the categorization logic 416 categorizes the feature into the targetable category. If the feature does not comply with the targeting policy 444, the categorization logic 416 categorizes the feature into the non-targetable category. Thus, the targetable category includes each of the features that complies with the targeting policy 444, and the non-targetable category includes each of the features that does not comply with the targeting policy 444. The categorization logic 416 may provide targetable feature information 434, indicating each feature in the targetable category and the values of each feature, to the ordering logic 418 for processing.

In an example embodiment, categorizing the features at step 404 includes categorizing each feature that has a computation cost that is greater than a cost threshold into the non-targetable category. The computation cost of a feature is the cost of computing the feature (e.g., by the machine learning model).

In another example embodiment, categorizing the features at step 404 includes categorizing each feature that does not comply with a designated privacy law into the non-targetable category. Examples of a designated privacy law include but are not limited to GDPR and the California Consumer Privacy Act.

At step 206, for each feature in the targetable category, values of the feature that are associated with the respective entities are ordered in an order that corresponds to the respective values. In an example implementation, for each feature in the targetable category, the ordering logic 418 orders the values of the feature that are associated with the respective entities. In an aspect of this implementation, the ordering logic 418 analyzes the targetable feature information 434 to identify the values of each feature. In accordance with this aspect, the ordering logic 418 compares the values of each feature to order the values. For instance, the ordering logic may arrange the values to be in descending order. The order logic 418 generates order information 418, which indicates the order of the values for each feature.

At step 208, for each feature in the targetable category, the entities are sorted among bins that are associated with the feature such that each bin includes a respective subset of the entities that is associated with a respective subset (e.g., sequential subset) of the ordered values of the feature. A sequential subset of ordered values is a subset in which the ordered values are sequential. In an example, sorting the entities for each feature in the targetable category at step 208 increases privacy and/or security of the entities. In an example implementation, for each feature in the targetable category, sorting logic 420 sorts the entities among the bins that are associated with the feature. The sorting logic 420 generates bin information 438, which indicates the bins that are associated with each feature and which of the entities are included in each bin. The sorting logic 448 further generates value subset information 448, which indicates, for each feature in the targetable category, the subset of the entities that is associated with each subset of the ordered values of the feature.

In an example embodiment, for each feature in the targetable category, sorting the entities among the bins at step 208 is performed by causing intervals defined by the respective subsets of the ordered values of the feature to be substantially the same. An interval defined by a subset of ordered values of a feature is a range of values that includes the ordered values in the subset. For instance, the range of values may extend from a lowest of the ordered values in the subset to a highest of the ordered values in the subset. In an aspect of this embodiment, intervals are deemed to be substantially the same so long as a difference between each pair of the intervals is less than a designated difference (e.g., 0.1%, 1%, 2%, or 5%). In another aspect of this embodiment, intervals are deemed to be substantially the same even if setting the intervals to be the same would result in a one or more of the ordered values not being included among the intervals, so long as (A) a number of the one or more ordered values is less than a number of the intervals, (B) one or more of the intervals are modified to accommodate the one or more ordered values, and (C) the ordered values of the feature in each subset remain ordered.

In another example embodiment, for each feature in the targetable category, sorting the entities among the bins at step 208 is performed by causing a number of the entities included in each bin to be substantially the same. In an aspect of this embodiment, each pair of bins is deemed to include substantially the same number of entities so long as a difference between the number of entities in a first bin of the pair and the number of entities in a second bin of the pair is less than a designated difference (e.g., 0.1%, 1%, 2%, or 5%).

At step 210, for each feature in the targetable category, a bin is selected from the bins that are associated with the feature based on the selected bin including a number of the entities having respective ranks that are within a designated range being greater than a number of the entities having respective ranks that are within the designated range in each of the other bins that are associated with the feature. In an example, selecting a bin for each feature in the targetable category at step 210 increases privacy and/or security of the entities. In another example, selecting a bin for each feature in the targetable category at step 210 increases accuracy, precision, and/or reliability of predictions that are provided by the privacy-preserving rules-based targeting logic 408. In yet another example, selecting a bin for each feature in the targetable category at step 210 reduces an amount of time and/or resources that is consumed (e.g., by the computing system 400) to target the entities. In still another example, selecting a bin for each feature in the targetable category at step 210 increases efficiency of a computing system (e.g., computing system 400) that is used to target the entities.

In an example implementation, for each feature in the targetable category, the bin selection logic 422 selects a bin from the bins that are associated with the feature. In an aspect of this implementation, the bin selection logic 422 analyzes rank range information 432, which indicates the designated range, the bin information 438, and the ranks 446 to identify which bin is to be selected for each feature. For instance, the bin selection logic 422 may analyze the bin information 438 to determine the bins that are associated with each feature and which of the entities are included in each bin. The bin selection logic 422 may cross-reference the ranks 446 with the entities in the bins for each feature to determine the rank of each entity in each bin. The bin selection logic 422 may compare the rank of each entity in each bin to the designated range, as indicated by the rank range information 432, to determine, for each feature, which bin includes a number of the entities having respective ranks that are within the designated range that is greater than a number of the entities having respective ranks that are within the designated range in each of the other bins that are associated with the feature.

At step 212, an interval for each feature in the targetable category that corresponds to the subset of the ordered values of the feature that is associated with the subset of the entities in the selected bin for the feature is defined. For instance, the interval for each feature may be defined based on a highest value and a lowest value in the subset of the ordered values of the feature that is associated with the subset of the entities in the selected bin for the feature. In an example implementation, the bin selection logic 422 defines the interval for each feature in the targetable category. For instance, the bin selection logic 422 may analyze the value subset information 448 to determine, for each feature of the targetable category, the subset of the ordered values of the feature that is associated with the subset of the entities in the selected bin for the feature. By analyzing the selected bin information 422 and the value subset information 448, the bin selection logic 422 may define the interval associated with the selected bin for each feature. The bin selection logic 422 generates interval information 440, which indicates the interval for each feature in the targetable category.

At step 214, a targeting rule is established. The targeting rule indicates a prerequisite that each entity to be targeted with an action satisfies a criterion. The criterion specifies that the value of each feature of the targetable category that is associated with the entity is included in the respective interval that is defined for the feature. In an example embodiment, the targeting rule specifies that each of the entities that is to be targeted with the action is to be included in the selected bins for the respective features of the targetable category. In an example, establishing the targeting rule at step 214 increases privacy and/or security of the entities. In another example, establishing the targeting rule at step 214 increases accuracy, precision, and/or reliability of predictions that are provided by the privacy-preserving rules-based targeting logic 408. In yet another example, establishing the targeting rule at step 214 reduces an amount of time and/or resources that is consumed (e.g., by the computing system 400) to target the entities. In still another example, establishing the targeting rule at step 214 increases efficiency of a computing system (e.g., computing system 400) that is used to target the entities.

In an example implementation, the rule establishment logic 424 establishes a targeting rule 442, which indicates the prerequisite that each entity to be targeted with an action 450 must satisfy the criterion. In an aspect of this implementation, the rule establishment logic 424 analyzes the interval information 440 to determine the interval for each feature. In accordance with this aspect, the rule establishment logic 424 sets the criterion to require that the value of each feature of the targetable category that is associated with an entity to be targeted with the action is included in the respective interval that is defined for the feature, as indicated by the interval information 440.

In some example embodiments, one or more steps 202, 204, 206, 208, 210, 212, and/or 214 of flowchart 200 may not be performed. Moreover, steps in addition to or in lieu of steps 202, 204, 206, 208, 210, 212, and/or 214 may be performed. For instance, in an example embodiment, the method of flowchart 200 further includes determining each of the ranks that is included in a top designated percentage of the ranks. For instance, the top designated percentage may be the top 1%, top 2%, or top 5% of the ranks. In an example implementation, the bin selection logic 422 determines each of the ranks that is included in the top designated percentage of the ranks. In an example aspect, the bin selection logic 422 analyzes the rank range information 432 to determine the top designated percentage. In accordance with this aspect, the bin selection logic 422 analyzes the ranks 446 of the respective entities to determine which of the ranks are in the top designated percentage. For instance, the bin selection logic 422 may multiply the designated percentage by a total number of the ranks 446 to determine a number of ranks that are in the top designated percentage of the ranks. For example, bin selection logic 422 may select the determined number of ranks such that each of the selected ranks is greater than each of the other selected ranks that is not selected. In accordance with this example, the bin selection logic 422 may order the ranks in a list in descending order and select the determined number of the ranks from the top of the list. In accordance with this embodiment, the selected bin for each feature includes a number of the entities having respective ranks in the top designated percentage that is greater than a number of the entities having respective ranks in the top designated percentage in each of the other bins that are associated with the feature.

In an aspect of this embodiment, the top designated percentage of the ranks corresponds to the entities that are most likely to purchase a product or service. Selecting the designated percentage may depend on any of a variety of factors, including but not limited to a number of the entities and the capacity of a system (e.g., computing system 400) to target the number of entities that are included in the designated percentage. In an example, the action may include triggering a call from a sales representative to each entity having a rank in the top designated percentage. In another example, the action may include triggering issuance of a discount coupon notification to each entity having a rank in the top designated percentage.

In another example embodiment, the designated range does not include a top specified percentage (e.g., top 1%, top 2%, or top 5%) of the ranks. In an aspect of this embodiment, the designated range is between the top 2% and the top 5% of the ranks. In another aspect of this embodiment, the designated range is between the top 2% and the top 10% of the ranks. In yet another aspect of this embodiment, the designated range is between the top 2% and the top 25% of the ranks. In an example, the action may include suggesting a document (e.g., a whitepaper) to each entity having a rank in the designated range. In another example, the action may include providing a recommendation to participate in a hands-on-lab to each entity having a rank in the designated range.

In yet another example embodiment, the method of flowchart 200 further includes performing the action with regard to a subset of the entities based on each entity in the subset satisfying the criterion. For instance, the action may be performed with regard to each of the entities that satisfies the criterion. In an example implementation, the action logic 426 performs the action 450 with regard to the subset of the entities. In an aspect of this implementation, the action logic 426 analyzes the entity information 430 to determine the values of each feature that are associated with the respective entities. The action logic 426 analyzes the targeting rule to identify the criterion. The action logic 426 compares the values of each feature that are associated with the respective entities to the targeting rule 442 to determine which of the entities satisfy the criterion.

In still another example embodiment, the subsets of the ordered values of each feature in the targetable category define respective intervals. In accordance with this embodiment, the method of flowchart 200 further includes, for each feature in the targetable category, combining each pair of the bins that are associated with subsets of the ordered values of the feature that define respective intervals that overlap. In an example implementation, the combining logic 428 combines each pair of the bins for each feature for which the respective intervals that overlap. In further accordance with this embodiment, the selected bin for each feature is selected in response to combining each pair of the bins for the feature for which the respective intervals overlap.

In another example embodiment, the method of flowchart 200 includes one or more of the steps of flowchart 300 shown in FIG. 3. As shown in FIG. 3, the method of flowchart 300 begins at step 302. In step 302, a determination is made that first and second intervals that are defined by respective subsets of the ordered values of a feature in the targetable category overlap. In an example implementation, the combing logic 428 determines that the first and second intervals overlap.

At step 304, the bins associated with the respective subsets of the ordered values of the feature that define the respective first and second intervals are combined to form a combined bin. In an example implementation, the combining logic 428 combines the bins associated with the respective first and second intervals to form the combined bin. In accordance with the embodiment of FIG. 3, the selected bin for each feature is selected in response to the combined bin being formed.

In an example embodiment, the methods of flowcharts 200 and 300 are model-agnostic. Accordingly, the methods of flowcharts 200 and 300 may be applied using any arbitrary machine learning model.

It will be recognized that the computing system 400 may not include one or more of the privacy-preserving rules-based targeting logic 408, the store 412, the ranking logic 414, the categorization logic 416, the ordering logic 418, the sorting logic 420, the bin selection logic 422, the rule establishment logic 424, the action logic 426, and/or the combining logic 428. Furthermore, the computing system 400 may include components in addition to or in lieu of the privacy-preserving rules-based targeting logic 408, the store 412, the ranking logic 414, the categorization logic 416, the ordering logic 418, the sorting logic 420, the bin selection logic 422, the rule establishment logic 424, the action logic 426, and/or the combining logic 428.

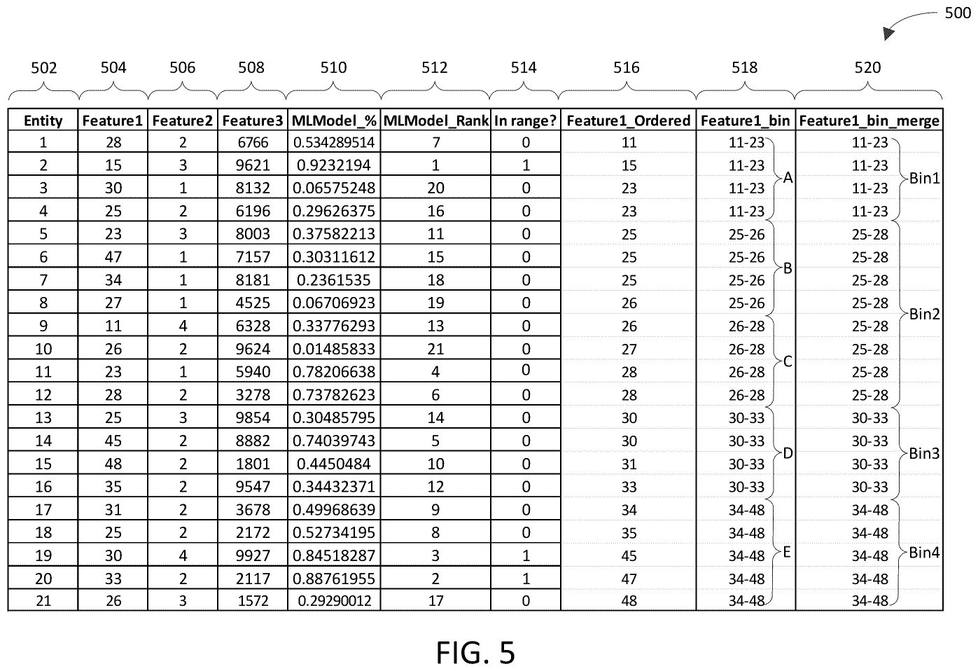

FIG. 5 is a spreadsheet 500 that illustrates ranking entities, ordering values of features, and sorting the entities among bins in accordance with an embodiment. The spreadsheet 500 includes ten columns 502, 504, 506, 508, 510, 512, 514, 516, 518, and 520. Column 502 includes twenty-one successively numbered cells, representing twenty-one respective entities. Column 504 depicts values of a first feature (i.e., Feature1) that are associated with the respective entities. Column 506 depicts values of a second feature (i.e., Feature2) that are associated with the respective entities. Column 508 depicts values of a third feature (i.e., Feature3) that are associated with the respective entities. Column 510 depicts probabilities (i.e., likelihoods) of the respective entities to perform a designated operation. Column 512 depicts ranks of the respective entities, which correspond to the respective probabilities of the respective entities to perform the designated operation. Accordingly, a relative higher probability in column 510 corresponds to a relatively higher rank in column 512. In an example implementation, the ranks are assigned to the respective entities in accordance with step 202 shown in FIG. 2.

Column 514 depicts binary indicators associated with the respective entities. Each of the binary indicators indicates whether the rank of the respective entity is within a designated range. A binary indicator having a value of “0” indicates that the rank of the respective entity is not within the designated range, whereas a binary indicator having a value of “1” indicates that the rank of the respective entity is within the designated range. The designated range has been selected as the top 15% of the ranks for non-limiting, illustrative purposes, though it will be recognized that the designated range can be any suitable range. Thus, the designated range includes the top three ranks (i.e., ranks 1, 2, and 3). As shown in the spreadsheet, entity 2 has the rank of 1; entity 20 has the rank of 2; and entity 19 has the rank of 3.

Column 516 lists the values of Feature 1 in ascending numerical order. In an example implementation, the values of Feature 1 are ordered in ascending numerical order in accordance with step 206 shown in FIG. 2.

The values of Feature 1 are associated with five bins corresponding to respective intervals for non-limiting, illustrative purposes. It will be recognized that the values of each feature may be associated with any suitable number of bins. As shown in column 518, the first four values in column 516 (i.e., 11, 15, 23, and 23) are associated with a first bin (labelled “A”) corresponding to a first interval of 11-23. As further shown in column 518, the next four values in column 516 (i.e., 25, 25, 25, and 26) are associated with a second bin (labelled “B”) corresponding to a second interval of 25-26. As further shown in column 518, the next four values in column 516 (i.e., 26, 27, 28, and 28) are associated with a third bin (labelled “C”) corresponding to a third interval of 26-28. As further shown in column 518, the next four values in column 516 (i.e., 30, 30, 31, and 33) are associated with a fourth bin (labelled “D”) corresponding to a fourth interval of 30-33. As further shown in column 518, the last five values in column 516 (i.e., 34, 35, 45, 47, and 48) are associated with a fifth bin (labelled “E”) corresponding to a fifth interval of 34-48. In an example implementation, the entities identified in column 502 are sorted among the bins indicated in column 518 such that each bin includes a respective subset of the entities that is associated with a respective subset of the values from column 516 in accordance with step 208 shown in FIG. 2.

It can be seen that the second interval (i.e., 25-26) and the third interval (i.e., 26-28) overlap. For instance, the second and third intervals share the value 26. In an example embodiment, intervals for a feature that overlap are combined. Accordingly, column 520 depicts the bin (and corresponding interval) with which each value of Feature 1 listed in column 516 is associated after the second and third intervals from column 518 are combined. As indicated in column 520, the values 11, 15, 23, and 23 from column 516 are associated with Bin1, which corresponds to the interval 11-23. The values 25, 25, 25, 26, 26, 27, 28, and 28 from column 516 are associated with Bin2, which corresponds to the interval 25-28 (as a result of combining the second and third intervals, labelled “B” and “C,” from column 518). The values 30, 30, 31, and 33 from column 516 are associated with Bin3, which corresponds to the interval 30-33. The values 34, 35, 45, 47, and 48 from column 516 are associated with Bin4, which corresponds to the interval 34-48.

As indicated by the binary values in column 514, the ranks of entities 2, 19, and 20 are within the designated range. Referring to column 504, it can be seen that entity 2 has a value of 15 for Feature 1; entity 19 has a value of 30 for Feature 1; and entity 20 has a value of 33 for Feature 1. Referring to column 520, it can be determined that entity 2 is in Bin1 because entity 2 has a value of 15, which is within the interval 11-23. It can be determined that entity 19 is in Bin3 because entity 19 has a value of 30, which is within the interval 30-33. It can be determined that entity 20 is in Bin3 because entity 20 has a value of 33, which is within the interval 30-33. Accordingly, for the entities 2, 19, and 20 having ranks within the designated range, one is in Bin1, and two are in Bin3. In an example implementation, because Bin3 includes the highest number of these entities, Bin3 is selected for Feature1 in accordance with step 210 shown in FIG. 2.

It will be assumed that each of Feature1, Feature2, and Feature3 is a targetable feature for purposes of illustration. An analysis may be performed with regard to Feature2 and Feature3 in a manner similar to the analysis described above with regard to Feature1 to determine bins that are to be selected for Feature2 and Feature3, respectively. In an example implementation, when a bin is selected for each of the features (i.e., Feature1, Feature2, and Feature3 in this example), a targeting rule is established in accordance with step 212 shown in FIG. 2 to require that the value of each targetable feature associated with an entity is included in a respective interval associated with the selected bin for the feature as a prerequisite for the entity to be targeted.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the privacy-preserving rules-based targeting logic 108, the privacy-preserving rules-based targeting logic 408, the ranking logic 414, the categorization logic 416, the ordering logic 418, the sorting logic 420, the bin selection logic 422, the rule establishment logic 424, the action logic 426, the combining logic 428, flowchart 200, and/or flowchart 300 may be implemented in hardware, software, firmware, or any combination thereof.

For example, any one or more of the privacy-preserving rules-based targeting logic 108, the privacy-preserving rules-based targeting logic 408, the ranking logic 414, the categorization logic 416, the ordering logic 418, the sorting logic 420, the bin selection logic 422, the rule establishment logic 424, the action logic 426, the combining logic 428, flowchart 200, and/or flowchart 300 may be implemented, at least in part, as computer program code configured to be executed in one or more processors.

In another example, any one or more of the privacy-preserving rules-based targeting logic 108, the privacy-preserving rules-based targeting logic 408, the ranking logic 414, the categorization logic 416, the ordering logic 418, the sorting logic 420, the bin selection logic 422, the rule establishment logic 424, the action logic 426, the combining logic 428, flowchart 200, and/or flowchart 300 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

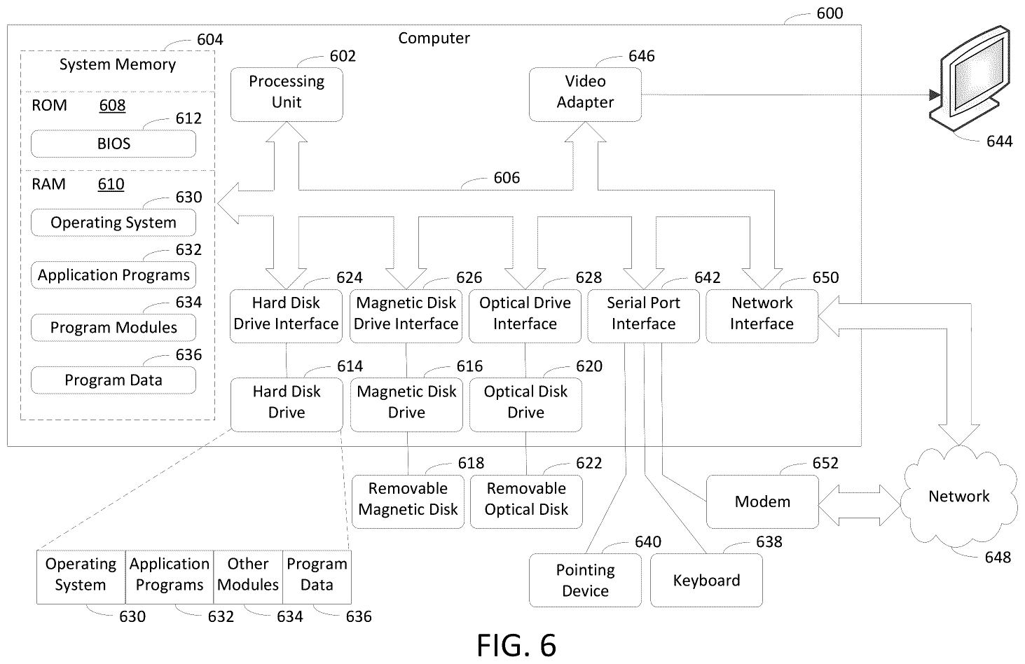

(A1) An example system (FIG. 1, 102A-102M, 106A-106N; FIG. 4, 400; FIG. 6, 600) comprises memory (FIG. 6, 604, 608, 610) and a processing system (FIG. 6, 602) coupled to the memory. The processing system is configured to assign (FIG. 2, 202) ranks (FIG. 4, 446) to respective entities using a machine learning model. The ranks correspond to respective likelihoods of the respective entities to perform a designated operation. The processing system is further configured to categorize (FIG. 2, 204) features that are associated with the entities among a targetable category and a non-targetable category. The targetable category includes each of the features that complies with a targeting policy(FIG. 4, 444). The non-targetable category includes each of the features that does not comply with the targeting policy. The processing system is further configured to, for each feature in the targetable category, order (FIG. 2, 206) values of the feature that are associated with the respective entities in an order that corresponds to the respective values. The processing system is further configured to, for each feature in the targetable category, sort (FIG. 2, 208) the entities among bins that are associated with the feature such that each bin includes a respective subset of the entities that is associated with a respective subset of the ordered values of the feature. The processing system is further configured to, for each feature in the targetable category, select (FIG. 2, 210) a bin from the bins that are associated with the feature based on the selected bin including a number of the entities having respective ranks that are within a designated range being greater than a number of the entities having respective ranks that are within the designated range in each of the other bins that are associated with the feature. The processing system is further configured to define (FIG. 2, 212) an interval for each feature in the targetable category that corresponds to the subset of the ordered values of the feature that is associated with the subset of the entities in the selected bin for the feature. The processing system is further configured to establish (FIG. 2, 214) a targeting rule (FIG. 4, 442), which indicates a prerequisite that each entity to be targeted with an action (FIG. 4, 450) satisfies a criterion. The criterion specifies that the value of each feature of the targetable category that is associated with the entity is included in the respective interval that is defined for the feature.

(A2) In the example system of A1, wherein the processing system is configured to: for each feature in the targetable category, sort the entities among the bins that are associated with the feature by causing intervals defined by the respective subsets of the ordered values of the feature to be substantially the same.

(A3) In the example system of any of A1-A2, wherein the processing system is configured to: for each feature in the targetable category, sort the entities among the bins that are associated with the feature by causing a number of the entities included in each bin to be substantially the same.

(A4) In the example system of any of A1-A3, wherein the processing system is further configured to: determine that first and second intervals that are defined by respective subsets of the ordered values of a feature in the targetable category overlap; and combine the bins associated with the respective subsets of the ordered values of the feature that define the respective first and second intervals to form a combined bin; and wherein the selected bin for each feature is selected in response to the combined bin being formed.

(A5) In the example system of any of A1-A4, wherein the subsets of the ordered values of each feature in the targetable category define respective intervals; wherein the processing system is further configured to: for each feature in the targetable category, combine each pair of the bins that are associated with subsets of the ordered values of the feature that define respective intervals that overlap; and wherein the selected bin for each feature is selected in response to combining each pair of the bins for the feature for which the respective intervals overlap.

(A6) In the example system of any of A1-A5, wherein the processing system is further configured to: determine each of the ranks that is included in a top designated percentage of the ranks; and wherein the selected bin for each feature includes a number of the entities having respective ranks in the top designated percentage that is greater than a number of the entities having respective ranks in the top designated percentage in each of the other bins that are associated with the feature.

(A7) In the example system of any of A1-A6, wherein the designated range does not include a top one percent of the ranks.

(A8) In the example system of any of A1-A7, wherein the processing system is further configured to: perform the action with regard to a subset of the entities based on each entity in the subset satisfying the criterion.

(A9) In the example system of any of A1-A8, wherein the processing system is further configured to: perform the action with regard to each of the entities that satisfies the criterion.

(A10) In the example system of any of A1-A9, wherein the processing system is configured to: categorize each feature that has a computation cost that is greater than a cost threshold into the non-targetable category.

(A11) In the example system of any of A1-A10, wherein the processing system is configured to: categorize each feature that does not comply with a designated privacy law into the non-targetable category.

(B1) An example method is implemented by a computing system (FIG. 1, 102A-102M, 106A-106N; FIG. 4, 400; FIG. 6, 600). The method comprises assigning (FIG. 2, 202) ranks (FIG. 4, 446) to respective entities using a machine learning model. The ranks correspond to respective likelihoods of the respective entities to perform a designated operation. The method further comprises categorizing (FIG. 2, 204) features that are associated with the entities among a targetable category and a non-targetable category. The targetable category includes each of the features that complies with a targeting policy (FIG. 4, 444). The non-targetable category includes each of the features that does not comply with the targeting policy. The method further comprises, for each feature in the targetable category, ordering (FIG. 2, 206) values of the feature that are associated with the respective entities in an order that corresponds to the respective values. The method further comprises, for each feature in the targetable category, sorting (FIG. 2, 208) the entities among bins that are associated with the feature such that each bin includes a respective subset of the entities that is associated with a respective subset of the ordered values of the feature. The method further comprises, for each feature in the targetable category, selecting (FIG. 2, 210) a bin from the bins that are associated with the feature based on the selected bin including a number of the entities having respective ranks that are within a designated range being greater than a number of the entities having respective ranks that are within the designated range in each of the other bins that are associated with the feature. The method further comprises defining (FIG. 2, 212) an interval for each feature in the targetable category that corresponds to the subset of the ordered values of the feature that is associated with the subset of the entities in the selected bin for the feature. The method further comprises establishing (FIG. 2, 214) a targeting rule (FIG. 4, 442), which indicates a prerequisite that each entity to be targeted with an action (FIG. 4, 450) satisfies a criterion. The criterion specifies that the value of each feature of the targetable category that is associated with the entity is included in the respective interval that is defined for the feature.

(B2) In the method of B 1, wherein for each feature in the targetable category, sorting the entities among the bins that are associated with the feature is performed by causing intervals defined by the respective subsets of the ordered values of the feature to be substantially the same.

(B3) In the method of any of B1-B2, wherein for each feature in the targetable category, sorting the entities among the bins that are associated with the feature is performed by causing a number of the entities included in each bin to be substantially the same.

(B4) In the method of any of B1-B3, further comprising: determining that first and second intervals that are defined by respective subsets of the ordered values of a feature in the targetable category overlap; and combining the bins associated with the respective subsets of the ordered values of the feature that define the respective first and second intervals to form a combined bin; wherein the selected bin for each feature is selected in response to the combined bin being formed.

(B5) In the method of any of B1-B4, wherein the subsets of the ordered values of each feature in the targetable category define respective intervals; wherein the method further comprises: for each feature in the targetable category, combining each pair of the bins that are associated with subsets of the ordered values of the feature that define respective intervals that overlap; and wherein the selected bin for each feature is selected in response to combining each pair of the bins for the feature for which the respective intervals overlap.

(B6) In the method of any of B1-B5, further comprising: determining each of the ranks that is included in a top designated percentage of the ranks; wherein the selected bin for each feature includes a number of the entities having respective ranks in the top designated percentage that is greater than a number of the entities having respective ranks in the top designated percentage in each of the other bins that are associated with the feature.

(B7) In the method of any of B1-B6, wherein the designated range does not include a top one percent of the ranks.

(B8) In the method of any of B1-B7, further comprising: performing the action with regard to a subset of the entities based on each entity in the subset satisfying the criterion.

(B9) In the method of any of B1-B8, further comprising: performing the action with regard to each of the entities that satisfies the criterion.

(B10) In the method of any of B1-B9, wherein categorizing the features that are associated with the entities comprises: categorizing each feature that has a computation cost that is greater than a cost threshold into the non-targetable category.

(B11) In the method of any of B1-B10, wherein categorizing the features that are associated with the entities comprises: categorizing each feature that does not comply with a designated privacy law into the non-targetable category.

(C1) An example computer program product (FIG. 6, 618, 622) comprising a computer-readable storage medium having instructions recorded thereon for enabling a processor-based system (FIG. 1, 102A-102M, 106A-106N; FIG. 4, 400; FIG. 6, 600) to perform operations. The operations comprise assigning (FIG. 2, 202) ranks (FIG. 4, 446) to respective entities using a machine learning model. The ranks correspond to respective likelihoods of the respective entities to perform a designated operation. The operations further comprise categorizing (FIG. 2, 204) features that are associated with the entities among a targetable category and a non-targetable category. The targetable category includes each of the features that complies with a targeting policy (FIG. 4, 444). The non-targetable category includes each of the features that does not comply with the targeting policy. The operations further comprise, for each feature in the targetable category, ordering (FIG. 2, 206) values of the feature that are associated with the respective entities in an order that corresponds to the respective values. The operations further comprise, for each feature in the targetable category, sorting (FIG. 2, 208) the entities among bins that are associated with the feature such that each bin includes a respective subset of the entities that is associated with a respective subset of the ordered values of the feature. The operations further comprise, for each feature in the targetable category, selecting (FIG. 2, 210) a bin from the bins that are associated with the feature based on the selected bin including a number of the entities having respective ranks that are within a designated range being greater than a number of the entities having respective ranks that are within the designated range in each of the other bins that are associated with the feature. The operations further comprise defining (FIG. 2, 212) an interval for each feature in the targetable category that corresponds to the subset of the ordered values of the feature that is associated with the subset of the entities in the selected bin for the feature. The operations further comprise establishing (FIG. 2, 214) a targeting rule (FIG. 4, 442), which indicates a prerequisite that each entity to be targeted with an action (FIG. 4, 450) satisfies a criterion. The criterion specifies that the value of each feature of the targetable category that is associated with the entity is included in the respective interval that is defined for the feature.

### III. Example Computer System

FIG. 6 depicts an example computer 600 in which embodiments may be implemented. Any one or more of the user devices 102A-102M and/or any one or more of the servers 106A-106N shown in FIG. 1 and/or computing system 400 shown in FIG. 4 may be implemented using computer 600, including one or more features of computer 600 and/or alternative features. Computer 600 may be a general-purpose computing device in the form of a conventional personal computer, a mobile computer, or a workstation, for example, or computer 600 may be a special purpose computing device. The description of computer 600 provided herein is provided for purposes of illustration, and is not intended to be limiting. Embodiments may be implemented in further types of computer systems, as would be known to persons skilled in the relevant art(s).

As shown in FIG. 6, computer 600 includes a processing unit 602, a system memory 604, and a bus 606 that couples various system components including system memory 604 to processing unit 602. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random access memory (RAM) 610. A basic input/output system 612 (BIOS) is stored in ROM 608.

Computer 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 630, one or more application programs 632, other program modules 634, and program data 636. Application programs 632 or program modules 634 may include, for example, computer program logic for implementing any one or more of (e.g., at least a portion of) the privacy-preserving rules-based targeting logic 108, the privacy-preserving rules-based targeting logic 408, the ranking logic 414, the categorization logic 416, the ordering logic 418, the sorting logic 420, the bin selection logic 422, the rule establishment logic 424, the action logic 426, the combining logic 428, flowchart 200 (including any step of flowchart 200), and/or flowchart 300 (including any step of flowchart 300), as described herein.

A user may enter commands and information into the computer 600 through input devices such as keyboard 638 and pointing device 640. Other input devices (not shown) may include a microphone, joystick, game pad, satellite dish, scanner, touch screen, camera, accelerometer, gyroscope, or the like. These and other input devices are often connected to the processing unit 602 through a serial port interface 642 that is coupled to bus 606, but may be connected by other interfaces, such as a parallel port, game port, or a universal serial bus (USB).

A display device 644 (e.g., a monitor) is also connected to bus 606 via an interface, such as a video adapter 646. In addition to display device 644, computer 600 may include other peripheral output devices (not shown) such as speakers and printers.

Computer 600 is connected to a network 648 (e.g., the Internet) through a network interface or adapter 650, a modem 652, or other means for establishing communications over the network. Modem 652, which may be internal or external, is connected to bus 606 via serial port interface 642.

As used herein, the terms “computer program medium” and “computer-readable storage medium” are used to generally refer to media (e.g., non-transitory media) such as the hard disk associated with hard disk drive 614, removable magnetic disk 618, removable optical disk 622, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 632 and other program modules 634) may be stored on the hard disk, magnetic disk, optical disk, ROM, or RAM. Such computer programs may also be received via network interface 650 or serial port interface 642. Such computer programs, when executed or loaded by an application, enable computer 600 to implement features of embodiments discussed herein. Accordingly, such computer programs represent controllers of the computer 600.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. CONCLUSION

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
memory; and
a processing system coupled to the memory, the processing system configured to:
assign ranks to respective entities using a machine learning model, the ranks corresponding to respective likelihoods of the respective entities to perform a designated operation;
categorize features that are associated with the entities among a targetable category and a non-targetable category, the targetable category including each of the features that complies with a targeting policy, the non-targetable category including each of the features that does not comply with the targeting policy;
for each feature in the targetable category, order values of the feature that are associated with the respective entities in an order that corresponds to the respective values;
for each feature in the targetable category, sort the entities among bins that are associated with the feature such that each bin includes a respective subset of the entities that is associated with a respective subset of the ordered values of the feature;
for each feature in the targetable category, select a bin from the bins that are associated with the feature based on the selected bin including a number of the entities having respective ranks that are within a designated range being greater than a number of the entities having respective ranks that are within the designated range in each of the other bins that are associated with the feature;
define an interval for each feature in the targetable category that corresponds to the subset of the ordered values of the feature that is associated with the subset of the entities in the selected bin for the feature; and
establish a targeting rule, which indicates a prerequisite that each entity to be targeted with an action satisfies a criterion, the criterion specifying that the value of each feature of the targetable category that is associated with the entity is included in the respective interval that is defined for the feature.

2. The system of claim 1, wherein the processing system is configured to:
for each feature in the targetable category, sort the entities among the bins that are associated with the feature by causing intervals defined by the respective subsets of the ordered values of the feature to be substantially the same.

3. The system of claim 1, wherein the processing system is configured to:
for each feature in the targetable category, sort the entities among the bins that are associated with the feature by causing a number of the entities included in each bin to be substantially the same.

4. The system of claim 1, wherein the processing system is further configured to:
determine that first and second intervals that are defined by respective subsets of the ordered values of a feature in the targetable category overlap; and
combine the bins associated with the respective subsets of the ordered values of the feature that define the respective first and second intervals to form a combined bin; and
wherein the selected bin for each feature is selected in response to the combined bin being formed.

5. The system of claim 1, wherein the processing system is further configured to:
determine each of the ranks that is included in a top designated percentage of the ranks; and
wherein the selected bin for each feature includes a number of the entities having respective ranks in the top designated percentage that is greater than a number of the entities having respective ranks in the top designated percentage in each of the other bins that are associated with the feature.

6. The system of claim 1, wherein the designated range does not include a top one percent of the ranks.

7. The system of claim 1, wherein the processing system is further configured to:
perform the action with regard to a subset of the entities based on each entity in the subset satisfying the criterion.

8. The system of claim 1, wherein the processing system is configured to:
categorize each feature that has a computation cost that is greater than a cost threshold into the non-targetable category.

9. The system of claim 1, wherein the processing system is configured to:
categorize each feature that does not comply with a designated privacy law into the non-targetable category.

10. A method implemented by a computing system, the method comprising:
assigning ranks to respective entities using a machine learning model, the ranks corresponding to respective likelihoods of the respective entities to perform a designated operation;
categorizing features that are associated with the entities among a targetable category and a non-targetable category, the targetable category including each of the features that complies with a targeting policy, the non-targetable category including each of the features that does not comply with the targeting policy;
for each feature in the targetable category, ordering values of the feature that are associated with the respective entities in an order that corresponds to the respective values;
for each feature in the targetable category, sorting the entities among bins that are associated with the feature such that each bin includes a respective subset of the entities that is associated with a respective subset of the ordered values of the feature;
for each feature in the targetable category, selecting a bin from the bins that are associated with the feature based on the selected bin including a number of the entities having respective ranks that are within a designated range being greater than a number of the entities having respective ranks that are within the designated range in each of the other bins that are associated with the feature;
defining an interval for each feature in the targetable category that corresponds to the subset of the ordered values of the feature that is associated with the subset of the entities in the selected bin for the feature; and
establishing a targeting rule, which indicates a prerequisite that each entity to be targeted with an action satisfies a criterion, the criterion specifying that the value of each feature of the targetable category that is associated with the entity is included in the respective interval that is defined for the feature.

11. The method of claim 10, wherein for each feature in the targetable category, sorting the entities among the bins that are associated with the feature is performed by causing intervals defined by the respective subsets of the ordered values of the feature to be substantially the same.

12. The method of claim 10, wherein for each feature in the targetable category, sorting the entities among the bins that are associated with the feature is performed by causing a number of the entities included in each bin to be substantially the same.

13. The method of claim 10, wherein the subsets of the ordered values of each feature in the targetable category define respective intervals;
wherein the method further comprises:
for each feature in the targetable category, combining each pair of the bins that are associated with subsets of the ordered values of the feature that define respective intervals that overlap; and
wherein the selected bin for each feature is selected in response to combining each pair of the bins for the feature for which the respective intervals overlap.

14. The method of claim 10, further comprising:
determining each of the ranks that is included in a top designated percentage of the ranks;
wherein the selected bin for each feature includes a number of the entities having respective ranks in the top designated percentage that is greater than a number of the entities having respective ranks in the top designated percentage in each of the other bins that are associated with the feature.

15. The method of claim 10, wherein the designated range does not include a top one percent of the ranks.

16. The method of claim 10, further comprising:
performing the action with regard to each of the entities that satisfies the criterion.

17. The method of claim 10, wherein categorizing the features that are associated with the entities comprises:
categorizing each feature that has a computation cost that is greater than a cost threshold into the non-targetable category.

18. The method of claim 10, wherein categorizing the features that are associated with the entities comprises:
categorizing each feature that does not comply with a designated privacy law into the non-targetable category.

19. A computer program product comprising a computer-readable storage medium having instructions recorded thereon for enabling a processor-based system to perform operations, the operations comprising:
assigning ranks to respective entities using a machine learning model, the ranks corresponding to respective likelihoods of the respective entities to perform a designated operation;
categorizing features that are associated with the entities among a targetable category and a non-targetable category, the targetable category including each of the features that complies with a targeting policy, the non-targetable category including each of the features that does not comply with the targeting policy;
for each feature in the targetable category, ordering values of the feature that are associated with the respective entities in an order that corresponds to the respective values;
for each feature in the targetable category, sorting the entities among bins that are associated with the feature such that each bin includes a respective subset of the entities that is associated with a respective subset of the ordered values of the feature;
for each feature in the targetable category, selecting a bin from the bins that are associated with the feature based on the selected bin including a number of the entities having respective ranks that are within a designated range being greater than a number of the entities having respective ranks that are within the designated range in each of the other bins that are associated with the feature;
defining an interval for each feature in the targetable category that corresponds to the subset of the ordered values of the feature that is associated with the subset of the entities in the selected bin for the feature; and
establishing a targeting rule, which indicates a prerequisite that each entity to be targeted with an action satisfies a criterion, the criterion specifying that the value of each feature of the targetable category that is associated with the entity is included in the respective interval that is defined for the feature.

20. The computer program product of claim 19, wherein the operations further comprise:
determining that first and second intervals that are defined by respective subsets of the ordered values of a feature in the targetable category overlap; and
combining the bins associated with the respective subsets of the ordered values of the feature that define the respective first and second intervals to form a combined bin;
wherein the selected bin for each feature is selected in response to the combined bin being formed.
